(19) United States
(12) Patent Application Publication
(10) Pub. No.: US 2026/0211699 A1
(43) Pub. Date: Jul. 23, 2026

(54) USING DISPOSITION INFORMATION IN OWNERSHIP VOUCHERS TO ENABLE ZERO-TOUCH ON-BOARDING OF DEVICES

(71) Applicant: Dell Products L.P., Round Rock, TX (US)

(72) Inventors: Bradley Keith Goodman, Nashua, NH (US); Joseph Brent Caisse, Burlington, VT (US); Mukesh Gupta, Shrewsbury, NJ (US); Christopher Ronald Dion, Marlborough, MA (US)

(21) Appl. No.: 19/034,203

(22) Filed: Jan. 22, 2025

(51) Int. Cl. G06F 9/445; G06F 21/44

(52) U.S. Cl. CPC G06F 9/44505; G06F 21/44

(57) ABSTRACT

A method for onboarding devices includes: connecting a device to a control plane; validating, after the connecting, an ownership voucher associated with the device; upon completing the validating, obtaining information about a set of permissible FIDO serviceinfo modules (FSIMs) associated with the device; and initiating onboarding of the device using the set of permissible FSIMs, wherein the device comprises a plurality of FSIMs and the set of permissible FSIMs is a subset of the plurality of FSIMs.

### BACKGROUND

Customers typically require specific configurations when of devices to include in their information technology (IT) infrastructures. To achieve this level of customization, the customers typically purchase a device with a specific hardware and software configuration and then manually configure the device to their needs. This requires the manufacture to maintain many different types of devices that have specific hardware and software configurations, which results in an inefficient use of resources.

### BRIEF DESCRIPTION OF DRAWINGS

FIG. 1 shows a system in accordance with one or more embodiments disclosed herein.

FIG. 2.1 shows a device in accordance with one or more embodiments disclosed herein.

FIG. 2.2 shows an ownership voucher in accordance with one or more embodiments disclosed herein.

FIG. 3 shows a method of configuring a device in accordance with one or more embodiments disclosed herein.

FIG. 4 shows a method of customizing an ownership voucher associated with the device in accordance with one or more embodiments disclosed herein.

FIG. 5 shows a method of provisioning a device using the ownership voucher associated with the device in accordance with one or more embodiments disclosed herein.

FIG. 6 shows a computing device in accordance with one or more embodiments disclosed herein.

### DETAILED DESCRIPTION

In general, companies sell devices that may be configured or onboarded at a client location rather than at a manufacturing facility. Companies may intend to configure or onboard the devices in a zero-touch manner that does not require any (or very limited) manual input or intervention from any technical staff. This zero-touch onboarding can reduce costs and integrate new devices seamlessly into existing frameworks. However, implementing zero-touch onboarding that can be configured for multiple use-cases can leave the device at risk for hacking or tampering in a way that is detrimental to the user. Accordingly, an efficient and practical solution is needed to manufacture a device that can securely onboard in multiple use-cases in a zero-touch manner.

While no solution/approaches exist for zero-touch onboarding of one device in multiple use-cases (for at least the aforementioned issue(s)), some of the existing solutions provide zero-touch onboarding. Such solutions include loading zero-touch onboarding credentials, such as FDO Device Onboarding, during manufacturing. When the device powers on, the device connects with a server on a network to verify the credentials and receive the configuration details. However, such approaches are limited in that they can only allow for a single secure onboarding configuration as any additional credentials loaded would be unused and leave security weakness that could be exploited. For any higher security implementation, where credentials may be limited, the device would only be able to be zero-touch configured for the specific credential allowed. Afterwards, the device would be unable to be used in any other implementation.

For at least the reasons discussed above and without requiring resource-intensive efforts (e.g., time, engineering, etc.) a different approach is needed (e.g. an approach to allow secure zero-touch onboarding for multiple use-cases which would increase the flexibility of device manufacturing and increase the functionality of the device).

Embodiments disclosed herein relate to methods and systems to onboard devices. As a result of the processes discussed below, one or more embodiments disclosed herein advantageously ensure that: (i) the device connects to a control plane; (ii) the control plane validates an ownership voucher associated with the device; (iii) the control plane obtains information about a set of permissible FIDO serviceinfo modules (FSIMs) associated with the device; and (iv) the device onboards using only the set of permissible FSIMs.

Specific embodiments will now be described with reference to the accompanying figures.

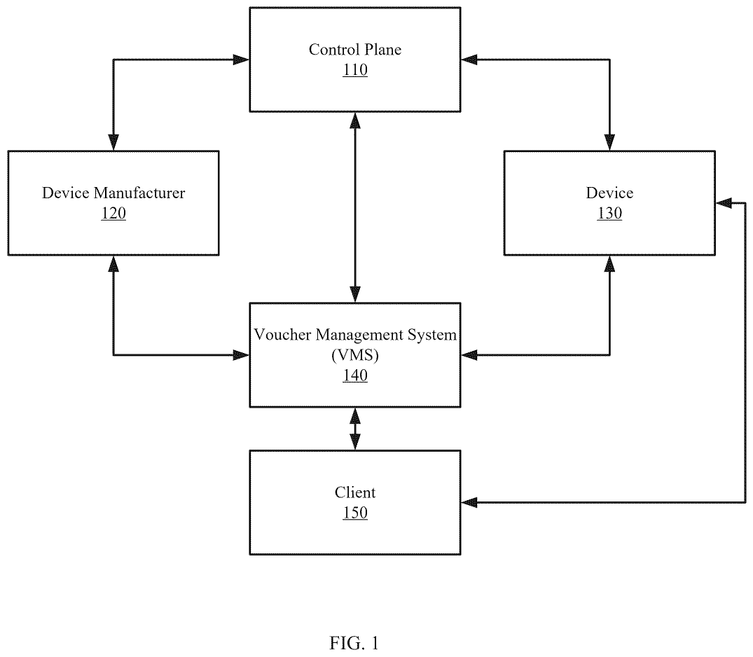

FIG. 1 shows a diagram of a system (100) in accordance with one or more embodiments disclosed herein. The system (100) includes a control plane (110), a device manufacturer (120), a device (130), a voucher management system (VMS) (140), and a client (150). The system (100) may include additional, fewer, and/or different components without departing from the scope of the embodiments disclosed herein. Each component may be operably/operatively connected to any of the other components via any combination of wired and/or wireless connections. Each component illustrated in FIG. 1 is discussed below.

In one or more embodiments, the control plane (110), the device manufacturer (120), the device (130), the VMS (140), and the client (150) may be (or may include) physical hardware or logical devices, as discussed below. While FIG. 1 shows a specific configuration of the system (100), other configurations may be used without departing form the scope of the embodiments disclosed herein. For example, although the control plane (110) and the VMS (140) are shown to be directly connected, they may be operatively connected through a communication network (not shown). As another non limiting example, the device manufacturer (120) and the device (130) are shown to not be connected but may be connected through a communication network or directly connected.

Further, the functioning of some of the components described, for example the control plane (110) or the device manufacturer (120), is not dependent upon the functioning and/or existence of the other components in the system (100). Rather, one or more components, e.g., the control plane (110) or the device manufacturer (120), may function independently and perform operations that do not require communication with other components. Accordingly, embodiments disclosed herein should not be limited to the configuration of components shown in FIG. 1.

As used herein, “communication” may refer to simple data passing, or may refer to two or more components coordinating a job. As used herein, the term “data” is intended to be broad in scope. In this manner, that term embraces, for example (but not limited to): a data stream (or stream data), data chunks, data blocks, atomic data, emails, objects of any type, files of any type (e.g., media files, spreadsheet files, database files, etc.), contacts, directories, sub-directories, volumes, etc.

In one or more embodiments, although the term zero-touch may be used by way of example, the principles of the present disclosure are not limited to any particular form of configuring or onboarding a device. Rather, such principles are equally applicable to any object capable of being onboarded. Further, configuring and onboarding will be used interchangeably in this detailed description.

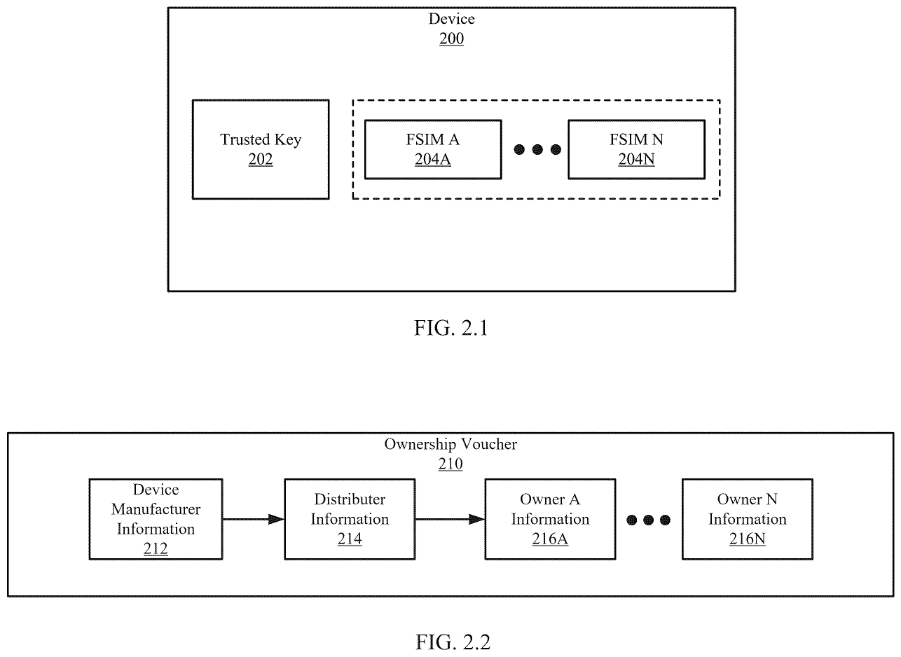

In one or more embodiments, the control plane (110) may be part of a network that manages device configuration data. In one or more embodiments, the control plane (110) may be selected by the client (150). In one or more embodiments, the control plane (110) may include functionality to connect with a device manufacturer (120) to receive an ownership voucher described in FIG. 2.2. The control plane (110) may also include the functionality to connect with the device (130) in order to collect data associated with the device that may be used during onboarding. In one or more embodiments, the data may include a list specifying one or more FSIMs pre-configured onto the device (130). By connecting with the device (130), the control plane (110) may include functionality to validate the ownership voucher and, upon successful validation, create a secure, encrypted tunnel between the control plane (110) and the device (130) through a key exchange. In one or more embodiments, the control plane (110) may install different software onto the device (130), may onboard the device according to end user instructions in accordance with the FSIMs listed in the ownership voucher, and/or may reject the device (130) if the ownership voucher is not validated. In one or more embodiments, the control plane (110) may be a cloud or platform that contains onboarding capabilities. One of ordinary skill will appreciate that the control plane (110) may perform other functionalities without departing from the scope of the embodiments disclosed herein.

In one or more embodiments, the device manufacturer (120) may include functionality to, e.g.,: (i) manufacture devices that may be used by clients at an end location, (ii) initialize ownership vouchers associated with the devices that travel to the end location in a parallel track to the device, (iii) load a plurality of FSIMs onto the device during manufacturing, where the FSIMs dictate the configuration capabilities of the device, (iv) connect with a VMS (140) to determine which FSIMs to load on to which devices, how to amend the ownership voucher to include FSIM data associated with the device, and where to send the ownership voucher based on an order request sent by the VMS (140), and (v) send the device to a warehouse or end location based on input from the VMS (140). For example, the device manufacturer (120) may create multiple, physically identical, devices containing the same hardware. The device manufacturer (120) may then load a different set of FSIMs to each individual device. The FSIMs may be one FSIM or a set of FSIMs based on the direction provided by the VMS (140). The device manufacturer (120) may then sort the devices based on the FSIMs and make the devices available for distribution based on the VMS (140).

Said another way, a device manufacturer may manufacture devices with the same hardware and then install the same software and FSIMs. While these devices are initially identical, as discussed below, the devices may be customized based on the permissible FSIMs associated with the devices. For example, a first device may be associated with a first set of permissible FSIMs and a second device (which is identical to the first device) may be associated with a second set of permissible FSIMs. The first set of permissible FSIMs and the second set of permissible FSIMs are each a subset of the install FSIMs (where each device has the same set of installed FSIMs). By using different set of these FSIMs (i.e., by associating each of the devices which a different set of permissible FSIMs), the initially identical devices may be configured differently, where the configurations are dictated by the specific set of permissible FSIMs associated with the each of the devices.

In one or more embodiments, the device (130) may include the functionality to connect to a control plane (110) first once powered on. The device (130) may contain multiple FSIMs that the control plane (110) would use to send configuration information to the device (130). The device may include functionality to onboard via the control plane using only the permissible FSIMs on the device without deleting (or using) the other non-permissible FSIMs that are also loaded on to the device. As an example, the device may receive configuration information based on FSIM 1. The rest of the FSIMs on the device would then not be part of the onboarding process and would be left unused and unable to connect to a network without an additional check from the control plane (110).

Continuing with the above example, the now configured device (130) may be sent to a new location, where a second control plane is used at the new location to configure devices. Once the device (130) is at the new location, the device may be powered on and receive configuration information from the second control plane. In this example, the second control plane determines that the permissible FSIM for the device is FSIM 2 (which is different from the permissible FSIMs that were specified by the control plane that was initially used to configure the device) from the multiple FSIMs loaded on to the device.

In one or more embodiments, the voucher management system (VMS) (140) may include the functionality to receive client orders. Further, the VMS (140) may include functionality to send inputs to the device manufacturer (120) based on the client orders. As a non-limiting example, the VMS (140) may receive an order from a client for a specified use-case. The VMS may then send an input to the device manufacturer (120) to manufacture the device and load a set of FSIMs based on the client order. As another example, the VMS (140) may send an input to the device manufacturer (120) to amend the ownership voucher to include the list of FSIMs and to send the ownership voucher and the device to the end location based on the client request. Additionally, the VMS (140) may include functionality to organize and manage stock produced by the device manufacturer (120). The stock may include devices that contain differing lists of the FSIMs. As an example, the VMS may sort multiple devices containing the same list of FSIMs, devices A, into one group, and may sort multiple devices containing a separate list of FSIMs, devices B, into another group. Continuing the example, the VMS (140) may preemptively order the device manufacturer (120) to create multiple devices containing the list of FSIMs prior to obtaining the client order. The VMS (140) may also include the functionality to send an order to the device manufacturer (120) to amend the ownership voucher to include disposition information associated with the device. The disposition information corresponds to the list of permissible FSIMs, which may be all or a subset of the FSIMs loaded onto the device. In one or more embodiments, the list of FSIMs described by the disposition information may contain all of the FSIMs included in the device or may be a partial list of FSIMs included in the device. In one or more embodiments, the list of FSIMs contained in the disposition information may be based on the client order.

In one or more embodiments, the client (150) may include functionality to send a client order to the VMS (140). The client order may be received by the VMS (140) or may be received by another component, not listed, and sent to the VMS afterwards. The client may also include the functionality to list a use-case or multiple use-cases for the device. In one or more embodiments, these use-cases may then be used to determine which FSIMs may be installed on the device or which device would be picked to fulfill the client order. Additionally, the client order may be used to determine which FSIMs are listed in the disposition information within the ownership voucher associated with the device manufactured or chosen to fulfill the client order.

Turning now to FIG. 2.1, FIG. 2.1 shows a device (200) in accordance with one or more embodiments disclosed herein. The device (200) includes a trusted key (202) and multiple FSIMs (e.g., FSIM A, FSIM N, etc.). The device (200) may include additional, fewer, and/or different components without departing from the scope of the embodiments disclosed herein. Each component may be operably/operatively connected to any of the other components via any combination of wired and/or wireless connections. Each component illustrated in FIG. 2.1 is discussed below.

In one or more embodiments, the trusted key (202) may include the functionality to uniquely identify the device (200) to a cloud, platform, or control plane (110) to which the device (200) connects. In one or more embodiments, the trusted key (202) may be obtained via a key exchange with the control plane and used to create a secure, encrypted tunnel between the device (130) and the control plane (110). The trusted key (202) may also be used to verify information in the ownership voucher. As an example, the device (200), once powered on, connects to a control plane (110), which then receives the trusted key (202). After receiving the trusted key, the control plane (110) compares the trusted key (202) to information within the ownership voucher. If the trusted key (202) matches with the information within the ownership voucher, the ownership voucher is then sent to the device (200) to establish the control plane as a device owner and the secure tunnel is created. In one or more embodiments, the trusted key (202) may be an encrypted text file stored in a file system on the device (200).

In one or more embodiments, the FSIMs (204) are executable code that is configured to execute on a device based on configuration information sent via the control plane (110). In one or more embodiments, the FSIMs may be implemented in the form of a module or a plug-in that is installed on to the device during manufacturing. In one or more embodiments, the FSIMs may be software installed on the device during manufacturing. In one or more embodiments, the FSIMs may include functionality to communicate with FSIMS installed on the control plane to allow the device to onboard in the desired fashion. As a non-limiting example, an FSIM with the capability to download and execute scripts to install arbitrary code may be installed on to a device during manufacturing and the code associated with the FSIM may be sent to a control plane. During onboarding, the FSIM may communicate with the code in the control plane to download and execute the scripts and install the arbitrary code onto the device the FSIM is installed. One of ordinary skill will appreciate that the FSIMs (202) may perform other functionalities without departing from the scope of the embodiments disclosed herein.

Turning to FIG. 2.2, FIG. 2.2 shows an ownership voucher (210) in accordance with one or more embodiments disclosed herein. The ownership voucher (210) includes device manufacturer information (212), distributer information (214), and owner information (e.g., owner A, owner N, etc.) (216). The ownership voucher (210) may include additional, fewer, and/or different components without departing from the scope of the embodiments disclosed herein. Each component may be sequentially ordered. Each component illustrated in FIG. 2.2 is discussed below.

In one or more embodiments, the ownership voucher (210) may include the functionality to store the sequential ownership information associated with the device (200). As the device (200) is physically transferred between parties, information is stored in the ownership voucher. In one or more embodiments, the information is stored as text strings in a text file. Any other data storing methods may be used without departing from the scope of the embodiments disclosed herein. In one or more embodiments, the information may include identification information (e.g. company names, geographical data, order history, transportation paths, etc.) associated with the owners. As a non-limiting example, the chain of ownership recorded by the ownership voucher may look like the following description. The device manufacturer creates the device (200) and ownership voucher (210) becoming the nominal first owner of the device (200). Accordingly, the device manufacturer information (212) is stored in the ownership voucher. The device (200) and ownership voucher (210) are then sent to a distributer. The distributer information (214) is then stored in the ownership voucher (210). Then the distributer sends the device (200) and ownership voucher (210) to a client who is listed as an owner. The ownership voucher then records the owner information (216). In one or more embodiments, every subsequent owner is also listed in the ownership voucher (210) as the device (200) continues to change ownership.

In one or more embodiments, the ownership voucher (210) may include the functionality to verify the identity of the device (200) by referencing the chain of ownership in the ownership voucher (210). By storing the owner information at each level of ownership, the ownership voucher (210) may increase the security in onboarding by verifying owner information. In one or more embodiments, if the owner attempting to onboard the device (200) does not match with the ownership voucher (210), the onboarding will fail.

In one or more embodiments, the ownership voucher may include the functionality to be amended to add disposition information. The disposition information may include a list of FSIMs preloaded into the device (200) associated with the ownership voucher (210). In one or more embodiments, the ownership voucher may be parsed by the control plane (110) to selectively enable the FSIMs (i.e., the permissible FSIMs) within the device (200).

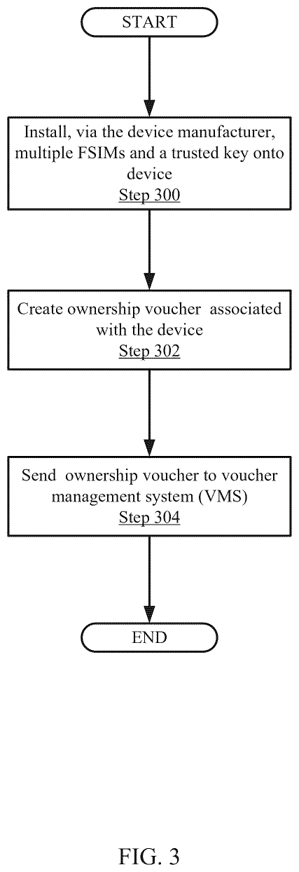

Turning to FIG. 3, FIG. 3 shows a method of configuring a device in accordance with one or more embodiments disclosed herein. While various steps in the method are presented and described sequentially, those skilled in the art will appreciate that some or all of the steps may be executed in different orders, may be combined or omitted, and some or all steps may be executed in parallel without departing from the scope of the embodiments disclosed herein. The method may be performed by, for example, a device manufacturer (e.g., 120, FIG. 1). Other components in the system may perform this method without departing from the scope of the disclosure.

In step 300, the device manufacturer, after receiving inputs from a VMS, installs multiple FSIMs and a trusted key onto a device. The FSIMs may be part of a larger set of FSIMs or may include a curated selection based on client use-cases. The FSIMs may include different levels of security. For example, the FSIMs may include an FSIM which requires root access to control file management and may include another FSIM which requires surface level network controls to connect to a Wi-Fi module.

In step 302, the device manufacturer creates the ownership voucher which includes the device manufacturer information as the first owner. In step 304, the device manufacturer sends the ownership voucher to the VMS to amend per the client order. In one or more embodiments, the method may end following step 304.

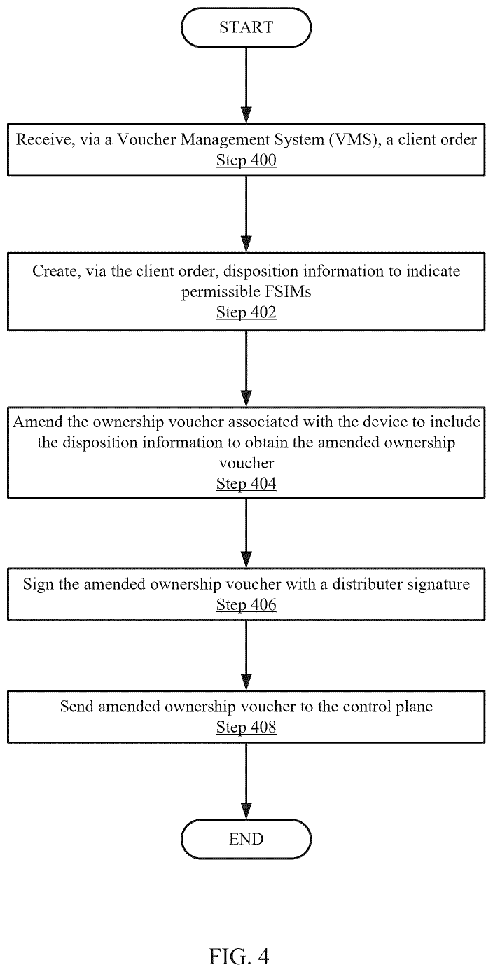

FIG. 4 shows a method of customizing an ownership voucher associated with the device in accordance with one or more embodiments disclosed herein. While various steps in the method are presented and described sequentially, those skilled in the art will appreciate that some or all of the steps may be executed in different orders, may be combined or omitted, and some or all steps may be executed in parallel without departing from the scope of the embodiments disclosed herein. The method may be performed by, for example, the voucher management system (VMS). Other components in the system may perform this method without departing from the scope of the disclosure.

In step 400, the VMS receives a client order. The client order may be a physical list or may be received digitally. The order may contain instructions specifying one device or may contain instructions specifying multiple devices. The order may contain instructions on how many FSIMs are needed to configure the device. In step 402, the VMS creates disposition information, based on the client order, to indicate permissible FSIMs within the FSIMs loaded on to the device used to fulfill the client order. The disposition information includes which FSIMs to enable and which FSIMs to disable (or otherwise not use) on the device. Those skilled in the art will appreciate that the disposition information may only include the subset of FSIMs that the control plane can use to onboard the device in accordance with the client order. In such scenarios, the other FSIMs on the device, which are not listed in the disposition information, are implicitly disabled or otherwise not used. In step 404, the VMS amends the ownership voucher associated with the device used to fulfill the client order to include the disposition information, thereby obtaining an amended ownership voucher.

In step 406, the VMS signs the amended ownership voucher with a distributer signature.

In step 408, the VMS sends the amended ownership voucher, which is signed, to the control plane of the client associated with the client order. At the same time, the VMS sends an order to the device manufacturer to send the device associated with the amended ownership voucher to the client (or, more specifically, to a physical location specified by client). In one or more embodiments, the method may end following step 408.

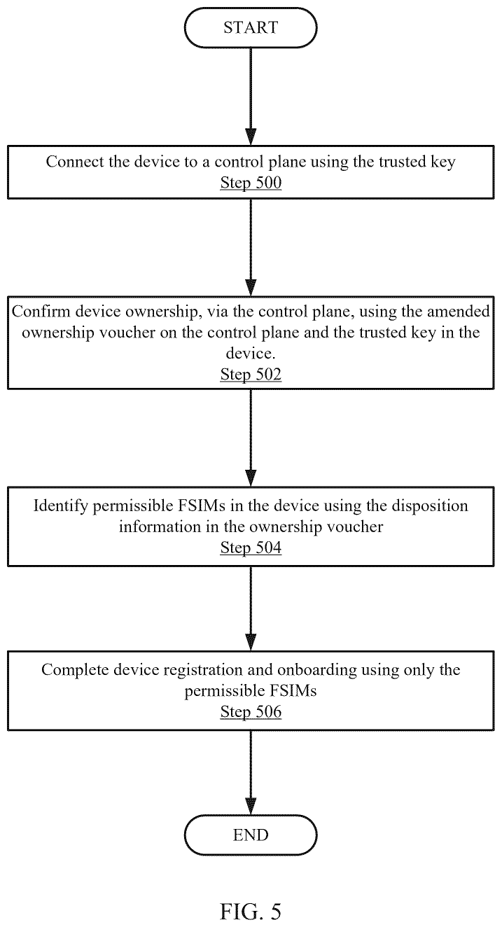

Turning to FIG. 5, FIG. 5 shows a method of provisioning a device using the ownership voucher associated with the device in accordance with one or more embodiments disclosed herein. While various steps in the method are presented and described sequentially, those skilled in the art will appreciate that some or all of the steps may be executed in different orders, may be combined or omitted, and some or all steps may be executed in parallel without departing from the scope of the embodiments disclosed herein. The method may be performed by, for example, the control plane. Other components in the system may perform this method without departing from the scope of the disclosure.

In step 500, after the device powers on, the control plane connects to the device using the trusted key. In step 502, the control plane confirms device ownership via the amended ownership voucher in the control plane and the trusted key in the device. Once the confirmation is complete, the control plane creates a secure tunnel between the control plane and the device. In step 504, the control plane parses the disposition information within the ownership voucher to identify the list of permissible FSIMs associated with the device. In step 506, the control plane completes device onboarding by executing only the FSIMs indicated by the disposition information. This enables the indicated FSIMs while disabling the extra FSIMs on the device, thereby maintaining security. In one or more embodiments, the method may end following step 506.

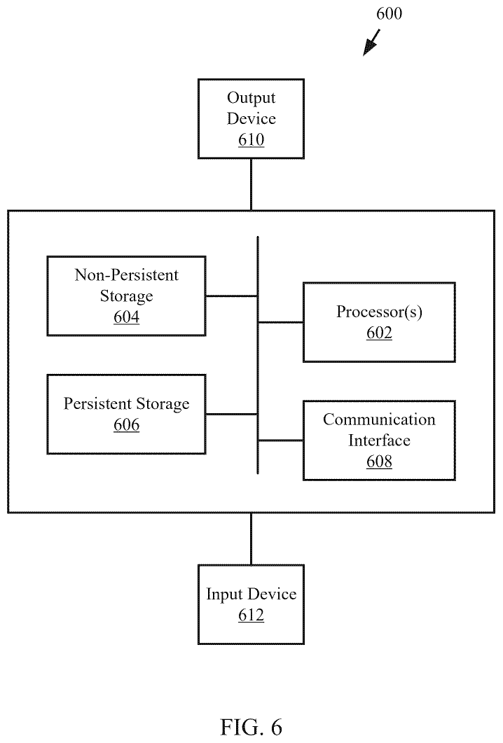

Embodiments of the disclosure may be implemented using computing devices. Turning to FIG. 6, FIG. 6 shows a diagram of a computing device (600) in accordance with one or more embodiments. The computing device (600) may include one or more computer processor(s) (602), non-persistent storage (604) (e.g., volatile memory, such as random access memory (RAM), cache memory), persistent storage (606) (e.g., a hard disk, an optical drive such as a compact disk (CD) drive or digital versatile disk (DVD) drive, a flash memory, etc.), a communication interface (608) (e.g., Bluetooth interface, infrared interface, network interface, optical interface, etc.), input devices (610), output devices (612), and numerous other elements (not shown) and functionalities. Each of these components is described below.

In one embodiment, the computer processor(s) (602) may be an integrated circuit for processing instructions. For example, the computer processor(s) (602) may be one or more cores or micro-cores of a processor. The computing device (600) may also include one or more input devices (610), such as a touchscreen, keyboard, mouse, microphone, touchpad, electronic pen, or any other type of input device. The communication interface (608) may include an integrated circuit for connecting the computing device (600) to a network (not shown) (e.g., a local area network (LAN), a wide area network (WAN) such as the Internet, mobile network, or any other type of network) and/or to another device, such as another computing device.

In one embodiment, the computing device (600) may include one or more output devices (612), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) (610, 612) may be locally or remotely connected to the computer processor(s) (602), non-persistent storage (604), and persistent storage (606). Many diverse types of computing devices exist, and the aforementioned input and output device(s) (610, 612) may take other forms.

The problems discussed above should be understood as being examples of problems solved by embodiments of the disclosure and the disclosure should not be limited to solving the same/similar problems. The disclosed disclosure is broadly applicable to address a range of problems beyond those discussed herein.

Specific embodiments are described above with reference to the accompanying figures. In the above detailed description of the embodiments, numerous specific details are set forth in order to provide a more thorough understanding of one or more embodiments. However, it will be apparent to one of ordinary skill in the art that the one or more embodiments may be practiced without these specific details. In other instances, well-known features have not been described in detail to avoid unnecessarily complicating the description.

In the prior description of the figures, any component described with regard to a figure, in various embodiments, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, throughout this application, elements of figures may be labeled as A to N. As used herein, the aforementioned labeling means that the element may include any number of items and does not require that the element include the same number of elements as any other item labeled as A to N unless otherwise specified. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other physical computer readable storage medium. Specifically, the software instructions may correspond to computer readable program code that, when executed by a processor(s), is configured to perform one or more embodiments described herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for onboarding devices, the method comprising:
connecting a device to a control plane;
validating, after the connecting, an ownership voucher associated with the device;
upon completing the validating, obtaining information about a set of permissible FIDO serviceinfo modules (FSIMs) associated with the device; and
initiating onboarding of the device using the set of permissible FSIMs, wherein the device comprises a plurality of FSIMs and the set of permissible FSIMs is a subset of the plurality of FSIMs.

2. The method of claim 1, wherein onboarding of the device using the set of permissible FSIMs results in a first configuration of the device.

3. The method of claim 2, further comprising:
connecting a second device to the control plane;
validating, after the connecting, a second ownership voucher associated with the second device;
upon completing the validating of the second device, obtaining information about a second set of permissible FSIMs associated with the second device; and
initiating onboarding of the second device using the second set of permissible FSIMs, wherein the second device comprises the plurality of FSIMs and the second set of permissible FSIMs is a second subset of the plurality of FSIMs.

4. The method of claim 3, wherein onboarding of the second device using the second set of permissible FSIMs results in a second configuration of the device, wherein the second configuration is different than the first configuration.

5. The method of claim 4, wherein the device and the second device are initially manufactured with the same hardware and software.

6. The method of claim 3, wherein the first set of FSIMs and the second set of FSIMs partially overlaps.

7. The method of claim 1, wherein the device is connected to the control plane using a trusted key.

8. A non-transitory computer readable medium comprising computer readable program code, which when executed by a computer processor enables the computer processor to perform a method for managing data in a storage system, the method comprising:
connecting a device to a control plane;
validating, after the connecting, an ownership voucher associated with the device;
upon completing the validating, obtaining information about a set of permissible FIDO serviceinfo modules (FSIMs) associated with the device; and
initiating onboarding of the device using the set of permissible FSIMs, wherein the device comprises a plurality of FSIMs and the set of permissible FSIMs is a subset of the plurality of FSIMs.

9. The non-transitory computer readable medium of claim 8, wherein onboarding of the device using the set of permissible FSIMs results in a first configuration of the device.

10. The non-transitory computer readable medium of claim 9, further comprising:
connecting a second device to the control plane;
validating, after the connecting, a second ownership voucher associated with the second device;
upon completing the validating of the second device, obtaining information about a second set of permissible FSIMs associated with the second device; and
initiating onboarding of the second device using the second set of permissible FSIMs, wherein the second device comprises the plurality of FSIMs and the second set of permissible FSIMs is a second subset of the plurality of FSIMs.

11. The non-transitory computer readable medium of claim 10, wherein onboarding of the second device using the second set of permissible FSIMs results in a second configuration of the device, wherein the second configuration is different than the first configuration.

12. The non-transitory computer readable medium of claim 11, wherein the device and the second device are initially manufactured with the same hardware and software.

13. The non-transitory computer readable medium of claim 10, wherein the first set of FSIMs and the second set of FSIMs partially overlaps.

14. The non-transitory computer readable medium of claim 8, wherein the device is connected to the control plane using a trusted key.

15. A control plane for onboarding devices, the control plane comprising:
a processor comprising circuitry;
memory comprising instructions, which when executed by the processor perform a method, the method comprising:
connecting a device to the control plane;
validating, after the connecting, an ownership voucher associated with the device;
upon completing the validating, obtaining information about a set of permissible FIDO serviceinfo modules (FSIMs) associated with the device; and
initiating onboarding of the device using the set of permissible FSIMs, wherein the device comprises a plurality of FSIMs and the set of permissible FSIMs is a subset of the plurality of FSIMs.

16. The control plane of claim 15, wherein onboarding of the device using the set of permissible FSIMs results in a first configuration of the device.

17. The control plane of claim 16, further comprising:
connecting a second device to the control plane;
validating, after the connecting, a second ownership voucher associated with the second device;
upon completing the validating of the second device, obtaining information about a second set of permissible FSIMs associated with the second device; and
initiating onboarding of the second device using the second set of permissible FSIMs, wherein the second device comprises the plurality of FSIMs and the second set of permissible FSIMs is a subset of the plurality of FSIMs.

18. The control plane of claim 17, wherein onboarding of the second device using the second set of permissible FSIMs results in a second configuration of the device, wherein the second configuration is different than the first configuration.

19. The control plane of claim 18, wherein the device and the second device are initially manufactured with the same hardware and software.

20. The control plane of claim 17, wherein the first set of FSIMs and the second set of FSIMs partially overlaps.
